(19) United States
(12) Patent Application Publication
(10) Pub. No.: US 2023/0127892 A1
(43) Pub. Date: Apr. 27, 2023

(54) MAGNETIC RESONANCE CHARGING SYSTEM

(71) Applicant: Tesc Innovation, Brumath (FR)

(72) Inventor: Sébastien Vanaud, Brumath (FR)

(21) Appl. No.: 17/915,830

(22) PCT Filed: Mar. 29, 2021
(86) PCT No.: PCT/EP2021/058087

§ 371 Date: Sep. 29, 2022

(30) Foreign Application Priority Data
Mar. 30, 2020 (FR) 2003118

(51) Int. Cl. H02J 50/12; H02M 7/48; H02M 1/00; H02M 3/158; H02J 50/70; H02J 50/80; H02M 1/08; H02M 1/36; H02J 7/00

(52) U.S. Cl. CPC H02J 50/12; H02M 7/4815; H02M 1/007; H02M 3/1586; H02J 50/70; H02J 50/80; H02M 1/081; H02M 1/36; H02J 7/0042; H02J 2207/20

(57) ABSTRACT

The present invention relates to a magnetic resonance charging system comprising a voltage source (1) and an inverter (2), said inverter (2) comprising a parallel LC inverter resonant circuit (3) and at least one charging plate (4), characterized in that said inverter resonant circuit (3) comprises a capacitor (32) connected in parallel to a primary winding (33) of said at least one charging plate (4) and in that said inverter (2) further comprises:
a measuring means (5) for measuring the instantaneous voltage across said inverter resonant circuit (3),
a phase shifter (6) connected to said measuring means (5)
an excitation means (7) connected to the phase shifter (6), able to inject energy from said voltage source (1) into the inverter resonant circuit (3) during each cycle observed by the measuring means (5), with a phase shift indicated by the phase shifter (6).

The present invention also relates to a method of operating a charging system according to the invention.

The present invention is in the field of electricity storage. It relates to a system for charging an accumulator, a rechargeable cell or a battery by magnetic resonance.

Existing systems designed to transmit energy by magnetic resonance usually comprise a primary resonant circuit, capable of transmitting a magnetic current to a secondary resonant circuit. The primary resonant circuit consists of an inductor and a capacitor, which can be connected in series or in parallel. This is called a series or parallel LC circuit.

The series LC circuit is often used for magnetic resonance charging, for example of electric vehicles such as bicycles, scooters, or cars. A charging system comprising a series LC resonant circuit has the advantage of being simple to manufacture and therefore inexpensive. Indeed, the electrical load across the LC series circuit has no influence on its resonant frequency. It is therefore sufficient to supply the series LC circuit with a sinusoidal voltage source at the same frequency for it to work. However, the LC series circuit has many disadvantages. It causes high voltages to appear at the coil and capacitor, which poses design problems. In addition, the series LC system operates at a constant RMS current of about 60 to 80 A in the resonant circuit, which generates more losses. In the event of large temperature variations, the resonant frequency of the series LC circuit may start to vary, resulting in a frequency shift relative to the voltage source, and thus a loss of efficiency. This is particularly problematic for an outdoor system, which must operate in both winter and summer. Finally, the series LC circuit requires a charge regulator on the secondary resonant circuit to capture the constant magnetic current, which increases complexity and cost.

The parallel LC circuit, on the other hand, is usually not used for magnetic resonant charging due to many obstacles. The parallel resonant circuit must be powered by a current source, which is complex and expensive. In addition, the electrical charge across the parallel LC circuit affects its resonant frequency, making the design and fabrication of a charging system with such an LC circuit more complex and expensive. Finally, a parallel LC resonant circuit can only power one secondary resonant circuit at a time.

It is an object of the present invention to provide a low-cost magnetic resonance charging system with improved performance.

It is an object of the present invention to meet at least part of the above objects by providing a self-oscillating parallel LC primary resonant circuit charging system. To this end, it proposes a magnetic resonance charging system comprising a voltage source (1) and an inverter (2), said inverter (2) comprising a parallel LC inverter resonant circuit (3) and at least one charging plate (4), characterized in that said inverter resonant circuit (3) comprises a capacitor (32) connected in parallel to a primary winding (33) of said at least one charging plate (4) and in that said inverter further comprises:
a measuring means for measuring the instantaneous voltage across said inverter resonant circuit,
a phase shifter connected to said measuring means,
an excitation means connected to the phase shifter, capable of injecting energy from said voltage source into the inverter resonant circuit during each cycle observed by the measurement means, with a phase shift indicated by the phase shifter.

Thanks to these arrangements, the resonant circuit can automatically resonate at its natural frequency, it is a self-oscillating circuit. This improves the efficiency of the charging system.

According to other features:
said excitation means may comprise:
   a tank inductor connected between said voltage source and a first terminal of the inverter resonant circuit,
   a charging diode having its anode connected to a second terminal of said inverter resonant circuit,
   a charging transistor whose drain is connected to the cathode of said charging diode, the source is connected to an output terminal, and the gate is connected to a driving means,
   a discharge diode whose anode is connected to the first terminal of said inverter resonant circuit,
   a discharge transistor whose drain is connected to the cathode of said discharge diode, the source is connected to an output terminal, and the gate is connected to said driving means,
   said driving means being connected to the phase shifter, and able to set the charging transistor in cut-off mode and the discharge transistor in saturation mode, then set the charging transistor in saturation mode and the discharge transistor in cut-off mode during each cycle observed by the measuring means, with a phase shift indicated by the phase shifter,
which is a simple, inexpensive and efficient embodiment of the invention,
the voltage source can deliver a voltage varying between 0 V and an adjustable maximum voltage, for example between 24 and 600 V, at a frequency between 20 kHz and 200 kHz, which makes it possible to supply most types of batteries, rechargeable cells and accumulators,
said measuring means can comprise a transformer, which is a simple, inexpensive and efficient embodiment,
said primary winding may comprise at least two wires connected in parallel and spaced apart from each other by at least 1 mm over at least 50% of their length, which makes it possible to obtain an efficiency similar to a single cable with a much larger cross-section; this is thus a simple, inexpensive and efficient embodiment,
said voltage source may be generated by a power supply able to convert an alternating current source, for example at a voltage of 220 V and a frequency of 50 Hz, into a voltage source delivering a voltage varying between 0 V and an adjustable maximum voltage, for example between 24 and 600 V, which allows for example to use the domestic electricity distribution network,
said power supply may comprise a filtering capacitor, having a capacitance of, for example, between 0.1 and 10 pF, making it possible to create in said voltage source an oscillation of the power at twice the frequency of said alternating current source, which makes it possible to supply several inverters from the same power supply, the starting of a second inverter being able to be carried out during the charge of a first inverter at the time of a passage in low power,
said inverter may comprise a microcontroller, capable of communicating with the power supply and of giving commands for starting or stopping the inverter, which is a simple and effective embodiment of the invention,
the charging system according to the invention may comprise a charge regulator able to communicate with the power supply and to send it a charging current request, which makes it possible to optimize the power sent by the power supply to the battery, accumulator or rechargeable cell to be charged.

The present invention also relates to a method of operating a charging system according to the invention comprising the following steps:
supplying a first inverter 2 with the power supply,
ordering the supply of a second inverter 2 by the power supply,
calculating the power at the first inverter 2,
when said power passes through a low value, for example less than 0.1× the maximum of said power, starting to supply the second inverter.

Thanks to these provisions, a single power supply may supply several inverters, the start-up of a second inverter being able to be carried out during the charging of a first inverter at the time of a passage in low power, which makes it possible to start the inverter at full power while avoiding the risk of breaking the components of the second inverter.

The present invention will be better understood from the detailed description that follows, with reference to the appended figures in which:

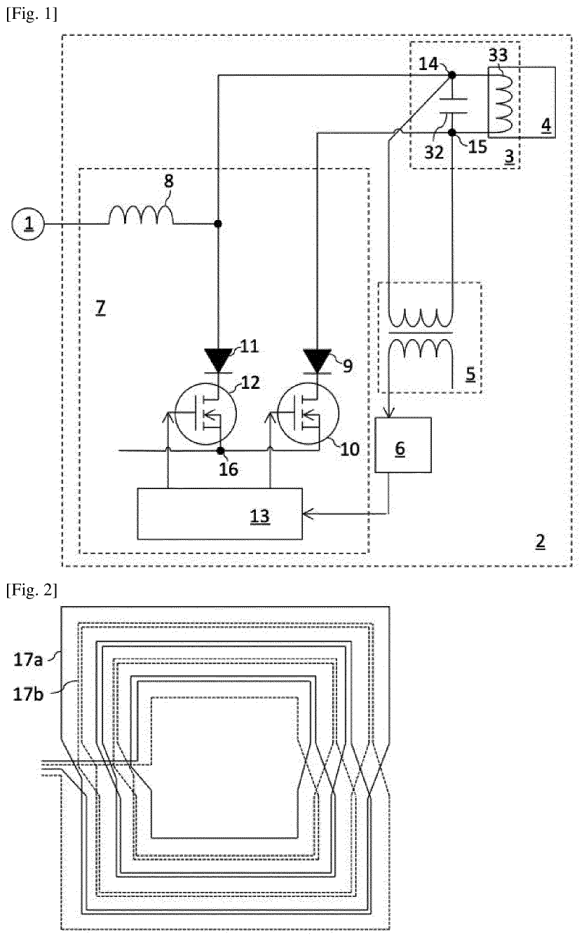

FIG. 1 is a schematic view of a preferred embodiment of the charging system according to the invention.

FIG. 2 is a schematic view of a preferred embodiment of the resonant circuit winding of the inverter of the charging system according to an invention.

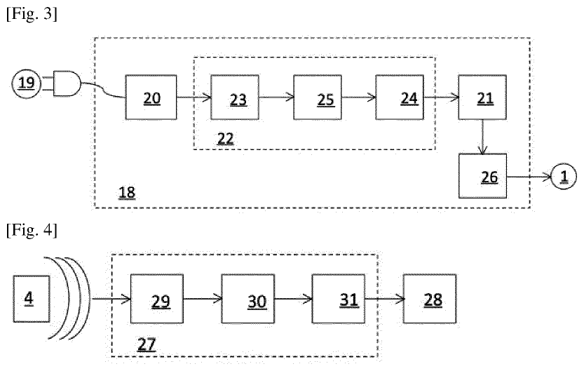

FIG. 3 is a schematic view of a preferred embodiment of a power supply of a charging system according to the invention.

FIG. 4 is a schematic view of a preferred embodiment of a charge regulator of a charging system according to the invention.

The charging system according to the invention, a preferred embodiment of which is shown in FIG. 1, comprises a voltage source 1 and an inverter 2 comprising a parallel LC inverter resonant circuit 3 comprising at least one charging plate 4. The charging plate 4 comprises a primary winding 33 able to generate a magnetic field for transferring energy, for example to a battery located on a movable object. The primary winding 33 is connected in parallel to a capacitor 32 to form said inverter resonant circuit 3.

Several charging plates 4 may be used, each comprising a primary winding 33 connected in parallel with the capacitor 32.

The voltage source 1 delivers a positive voltage, which can oscillate between 0 V and a maximum voltage value, for example between 24 and 600 V. The maximum voltage value depends on the power request at the output of the charging system.

The inverter 2 includes a measuring means 5 for measuring the instantaneous voltage across the capacitor 32. This measuring means is preferably a transformer.

The signal measured by the measuring means 5 is sent to a phase shifter 6, which introduces a phase shift before sending it to an excitation means 7. The phase shift is a time delay or advance with respect to the zero crossing of the voltage measured across the inverter resonant circuit 3. The excitation means 7 is adapted to inject energy from the voltage source 1 into the inverter resonant circuit 3 at each cycle observed by the measuring means 5, with a phase shift indicated by the phase shifter 6.

The excitation means 7 is therefore able to inject energy into the inverter resonant circuit 3 at the frequency of the signal measured by the measuring means 5. The inverter resonant circuit 3 is thus automatically excited at its natural frequency. There is no frequency forcing, which improves the efficiency of the charging system.

The phase shift makes it possible to limit or even absorb current peaks in the inverter and thus avoid the destruction of its components, in particular of any transistors. These current peaks appear when energy is suddenly injected into the circuit and cause voltage peaks which, if they are not attenuated, risk causing the breakage of certain components, in particular optional transistors. Moreover, the phase shift allows to absorb the inductance introduced by the length of cable between the inverter and the resonant circuit of the charging plate, which allows to feed a resonant circuit in a charging plate placed at a great distance from the inverter.

In a preferred embodiment of the invention, the driving means 7 comprises a tank inductor 8, a charging diode 9, a charging transistor 10, a discharge diode 11, a discharge transistor 12 and a driving means 13 for the diodes 9, 11, arranged as described below:

The tank inductor 8 is connected between the voltage source and a first terminal 14 of the inverter resonant circuit 3. The tank inductor 8 has a relatively small value, for example between 500 pH and 3 mH. The value of the tank inductor 8 varies depending on the power at which the charging device is to be operated. If the inductance value is too low, the inverter will switch off and the risk of breakage will increase, whereas if the inductance value is too high, the voltage drop across the inverter will be too high.

The anode of the charging diode 9 is connected to the second terminal 15 of the inverter resonant circuit 3, and its cathode is connected to the drain of a charging transistor 10. The source of the charging transistor 10 is connected to an output terminal 16, while its gate is connected to the driving means 13.

The anode of the discharge diode 11 is connected to the first terminal 14 of the inverter resonant circuit 3, and its cathode is connected to the drain of the discharge transistor 12. The source of the discharge transistor 12 is connected to the output terminal 16, while its gate is connected to the driving means 13.

The driving means 13, based on this phase-shifted measured signal from the phase shifter 6, successively drives the charging transistor 10 to cut-off mode and the discharge transistor 12 to saturation mode, then the charging transistor 10 to saturation mode and the discharge transistor 12 to cut-off mode.

When the charging transistor 10 is in cut-off mode and the discharge transistor 12 is in saturation mode, energy is accumulated in the tank inductor 8. Then when the charging transistor 10 is in saturation mode and the discharge transistor 12 is in cut-off mode, the accumulated energy is released into the inverter resonant circuit 3. The tank inductor 8 is used to transform the voltage source 1 into a current source.

The charging and discharge transistors 10 and 12 are preferably MOSFET (insulated-gate field-effect transistor) or IGBT (insulated-gate bipolar transistor) type transistors.

In this embodiment, the inverter may be started according to a method comprising the following steps:
request for starting the inverter,
the discharge transistor is set to cut-off mode, while the charge transistor is set to saturation mode,
a small current is sent to the inverter resonant circuit 3 and initiates the oscillation,
the resonance frequency of the inverter resonant circuit 3 is read by the measuring means 5 and if this and possibly other parameters are correct, full power is released in the inverter.

The driving means 7 may be realized in different ways than the one described above and illustrated in FIG. 1. For example, the driving means 7 may comprise four transistors and four diodes, which makes it possible to inject energy into the inverter resonant circuit 3 not only during charging, but also during discharging.

The inverter resonant circuit 3 consists of an inductor wound in parallel with a capacitor to form a parallel RLC circuit.

In a preferred embodiment of the invention, an example of which is shown in FIG. 2, the primary winding 33 is realized by a structure having two wires 17, for example Litz wires, connected in parallel. In FIG. 2, two wires 17a, 17b are shown. The wires 17 are spaced apart from each other over at least 50% of their length, which makes it possible to obtain the same magnetic flux density as a flat cable with a larger cross-section, in particular one whose cross-section would encompass the spaced-apart wires 17. The spacing is preferably at least 1 mm. This allows the overall value of the inductance of the plate 4 to be reduced (paralleling two inductors) and thus reduce the current flowing in the primary winding 33. The same efficiency is thus obtained with significantly less cable mass, thus reducing costs. Preferably, the wires 17 are crossed after each winding turn, or after a certain number of winding turns, so that they have the same overall length, and thus the same inductance and resistance value. The circuit thus formed is thus balanced. The two wires 17 are always parallel, even when crossing, in the sense that they are constantly spaced from each other, preferably by a constant distance.

The voltage source 1 may be generated by a power supply 18, shown in FIG. 3, suitable for generating the voltage source 1 from an alternating current source 19. The power supply 18 may thus be connected directly to the AC network, for example 220V/50 Hz, and deliver the voltage source 1 required for the proper operation of the inverter 2. In particular, the power supply is able to generate the required power envelope in relation to the power required at the output of the charging system.

The power supply 18 may comprise an EMC filter 20 at the input, allowing to filter the disturbances induced downstream and thus to not disturb the electrical network.

The power supply 18 may also include a transformer 21 at the input, or if necessary at the output of the EMC filter 20. The transformer 21 allows to modify the intensity and current values. It allows to realize a galvanic isolation of the stage 22 on the output 1. Thus the ground reference of the inverter 2 is the ground.

The power supply may include a chopping module 22, located before the transformer input. The chopper module 22 allows the frequency of the current to be raised, for example from a frequency of 50 Hz at the input to a frequency between 20 KHz and 200 KHz at the output. This is necessary in order to supply the transformer 21, if it is a high-frequency transformer. The use of a high-frequency transformer is preferred because the size of such a transformer is small.

The chopper module 22 may consist of a diode rectifier 23, to the output of which a chopper 24 is connected. The chopper 24 allows the power of the current to be adjusted according to the needs of the charging system. In a preferred embodiment of the invention, a filtering capacitor 25 is arranged between the diode rectifier 23 and the chopper 24. The capacitance of the filtering capacitor may be between 0.1 and 10 pF, and may typically be a few pF. Such a relatively low filtering allows, during a power transfer, to obtain a “ripple” effect on this power, i.e. the appearance of an oscillation at twice the frequency of the network. Due to this oscillation, the power transferred to an inverter 2 goes through minimums. This has an advantage when the charging system has several inverters 2 connected to a single power supply 18. When the power supply 18 is transferring power to a first inverter 2, if a second inverter 2 is started, it is possible to wait for the passage of a power minimum within the power supply 18 before allowing the second inverter to start. Thus, the second inverter 2 may be started at full power, without the risk of a power peak damaging a component.

Finally, the power supply may include a rectifier 26, capable of converting the alternating current at the output of the transformer into a current whose voltage varies between 0 V and an adjustable maximum value, for example between 24 and 600 V, to obtain the voltage source 1.

The inverter 2 may comprise a microcontroller able to give commands to start and stop the inverter 2 based on the following data: the operating frequency of the inverter resonant circuit 3, retrieved by the measuring means 5, the values of voltages and currents, retrieved for example at the first terminal 14 of the inverter resonant circuit 3 and at the output terminal 16. The microcontroller may also be able to communicate with the power supply 18 so that if the power supply 18 is already powering another inverter 2, the microcontroller authorizes the start of the inverter 2 at the right time, when passing at a low power. To do this, the microcontroller of the inverter 2 may also calculate the power from several measurements taken in the inverter 2. These measurements may include the current and voltage in the inverter resonant circuit loop 3, the current and voltage at the output of the voltage source 1, and the voltage zero crossing times in the inverter 2.

The power supply 18 may also include a microcontroller capable of issuing on and off commands to the power supply 18 based on the following data: temperature of the power components, values of voltages and currents in the chopper module and the rectifier.

The charging system according to the invention may include a charge regulator 27, an embodiment of which is illustrated in FIG. 4. The charge controller makes it possible to convert the magnetic energy generated by the charging plate 4 into an electrical signal that can be used to charge/recharge a charge 28, for example a battery, accumulator or rechargeable cell.

The charge regulator 27 includes a secondary resonant circuit 29 tuned in frequency with the primary resonant circuit of the charge plate 4. If the charge 28 is a battery requiring constant current charging, the secondary resonant circuit 29 is preferably a series LC circuit. If the charge is an AC/DC converter, for example a battery charger to be connected to the 220V AC network, then the secondary resonant circuit is preferably a parallel LC circuit in order to obtain a large DC voltage at the output of the charge regulator.

At the output of the secondary resonant circuit 29, the charge regulator comprises a rectifier and filtering module 30, allowing to transform the current coming from the secondary resonant circuit 29 into a direct current suitable for charging the charge 28.

In the case of low power, for example a charging voltage below 50V, a BUCK converter 31 is preferably added at the output of the rectifier and filtering module 30, before the current is sent to the charge 28. The BUCK converter allows the voltage of the current to be lowered to the value required by the charge 28.

The charge regulator 27 may include a microcontroller capable of communicating with the power supply 18. Thus, the charge regulator 27 may send a charging current request for the charge 28 directly to the power supply 18, which will attempt to satisfy that request.

In the case where the power supply 18 comprises a filtering capacitor 25 making it possible to oscillate the power generated by the power supply 18 at twice the frequency of the current source 19, the oscillation being at a frequency of 100 Hz, for example, the charging of the charge 28 may occur in two phases repeating at the network frequency: a charging phase, when the voltage delivered by the power supply 18 is higher than the voltage across the charge 28, then a relaxation phase, when the voltage delivered by the power supply 18 is lower than the voltage across the load 28. Thus, contrary to a conventional charging system, the power supply 18 does not send a continuous power which the charge regulator 27 can dispose of, but sends just the necessary power requested by the load 28. The overall efficiency of the charging system is thus optimized.

The charging system according to the invention may be used in a charging method comprising the following steps:
supplying a first inverter 2 with the power supply 18,
ordering the supply of a second inverter 2 by the power supply 18,
calculating the power at the first inverter 2,
when said power passes through a low value, for example less than 0.1× the maximum of said power, starting to supply the second inverter 2.

Although the above description is based on particular embodiments, it is by no means limiting the scope of the invention, and modifications may be made, in particular by substitution of technical equivalents or by different combination of all or part of the features developed above.

1. A magnetic resonance charging system comprising a voltage source (1) and an inverter (2), said inverter (2) comprising a parallel LC inverter resonant circuit (3) and at least one charging plate (4), characterized in that said inverter resonant circuit (3) comprises a capacitor (32) connected in parallel to a primary winding (33) of said at least one charging plate (4) and in that said inverter (2) further comprises:
a measuring means (5) for measuring the instantaneous voltage across said inverter resonant circuit (3),
a phase shifter (6) connected to said measuring means (5),
an excitation means (7) connected to the phase shifter (6), able to inject energy from said voltage source (1) into the inverter resonant circuit (3) at each cycle observed by the measuring means (5), with a phase shift indicated by the phase shifter (6), the phase shift being a time delay or advance with respect to the zero-crossing of the voltage measured across the inverter resonant circuit (3).

2. The charging system according to claim 1, wherein said excitation means comprises:
a tank inductor (8) connected between said voltage source (1) and a first terminal (14) of the inverter resonant circuit (3),
a charging diode (9) whose anode is connected to a second terminal (15) of said inverter resonant circuit (3),
a charging transistor (10) whose drain is connected to the cathode of said charging diode (9), the source is connected to an output terminal (16), and the gate is connected to a driving means (13),
a discharge diode (11) whose anode is connected to the first terminal (14) of said inverter resonant circuit (3),
a discharge transistor (12) whose drain is connected to the cathode of said discharge diode (11), the source is connected to an output terminal (16), and the gate is connected to said driving means (13),
said driving means (13) being connected to the phase shifter (6), and able to set the charging transistor (10) to cut-off mode and the discharging transistor (12) to saturation mode, then set the charging transistor (10) to saturation mode and the discharging transistor (12) to cut-off mode during each cycle observed by the measuring means (6), with a phase shift indicated by the phase shifter (6).

3. The charging system according to claim 1, wherein the voltage source (1) delivers a voltage varying between 0 V and an adjustable maximum voltage, for example between 24 and 600 V, at a frequency between 20 KHz and 200 kHz.

4. The charging system according to claim 1, wherein said measuring means (5) comprises a transformer.

5. The charging system according to claim 1, wherein said primary winding (33) comprises at least two wires (17a, 17b) connected in parallel and spaced apart from each other by at least 1 mm over at least 50% of their length.

6. The charging system according to claim 1, wherein said voltage source (1) is generated by a power supply (18) capable of converting an AC source (19), for example at a voltage of 220 V and a frequency of 50 Hz, into a voltage source (1) delivering a voltage varying between 0 V and an adjustable maximum voltage, for example between 24 and 600 V.

7. The charging system according to claim 1, wherein said inverter (2) comprises a microcontroller, capable of communicating with the power supply (18) and of giving commands for starting or stopping the inverter (2).

8. The charging system according to claim 6, comprising a charge controller (27) able to communicate with the power supply (18) and to send it a charging current request.

9. The charging system according to claim 6, wherein said power supply (18) comprises a filtering capacitor (25), having a capacitance for example between 0.1 and 10 pF, allowing to create in said voltage source (1) a power oscillation at twice the frequency of said AC source (19).

10. The method of using a charging system according to claim 1 comprising at least two inverters (2), comprising the following steps:
supplying a first inverter (2) with power (18),
ordering the supply of a second inverter (2) by the power supply (18)
calculating the power at the first inverter (2),
when said power passes through a low value, for example less than 0.1× the maximum of said power, starting to supply the second inverter (2).
